(19) United States
(12) Patent Application Publication
(10) Pub. No.: US 2003/0106203 A1
(43) Pub. Date: Jun. 12, 2003

(54) Waveguide and manufacturing method thereof

(76) Inventors: Muneaki Mukuda, Tokyo (JP); Takayuki Inuzuka, Tokyo (JP); Naosi Yamada, Tokyo (JP); Hideki Asao, Tokyo (JP); Kazuhisa Henmi, Tokyo (JP)

Correspondence Address: LEYDIG VOIT & MAYER, LTD, 700 THIRTEENTH ST. NW, SUITE 300, WASHINGTON, DC, 20005-3960, US

(21) Appl. No.: 10/333,359

(22) PCT Filed: Jun. 10, 2002
(86) PCT No.: PCT/JP02/05742

(30) Foreign Application Priority Data
Jul. 6, 2001 (JP) 2001-206770

(51) Int. Cl. H01P 1/04

(52) U.S. Cl. 29/600; 333/254

(57) ABSTRACT

After through holes (25) are formed on flange portions (23) of a pair of waveguide units (20) and (21), and the pair of the waveguide units (20) and (21), in which the through holes (25) have been formed, are joined together, insert molding of the pair of the joined waveguide units (20) and (21) is executed using a thermoplastic resin to form a resin cover (30) filled into the through holes (25) and covers the pair of the waveguide units (20) and (21). Accordingly, an improved assembling efficiency, stronger fastening force between waveguide units, and better air-tightness of the waveguide are obtained by using resin molding to fasten the pair of the waveguides.

### TECHNICAL FIELD

The present invention relates to a microwave waveguide (hereinafter “waveguide”) that is formed with a pair of waveguide units, and a manufacturing method thereof.

### BACKGROUND ART

Though it was common to make the microwave waveguides with metal, recently, they are also made of resins.

FIG. 7 shows a prior art waveguide made of a resin (Japanese Patent Application Laid-Open No. 6-104615). This prior art waveguide is manufactured as follows. That is, a base 101 is made of thermoplastic plastics and, this base 101 has a U-shaped hollow-space 100. Moreover, a cover 103 is also made of thermoplastic plastics and, this cover 103 also has a U-shaped hollow-space 102. The base 101 and the cover 103 are bonded with an epoxy adhesive to form a waveguide 104. A layer of copper is formed on the inner surface of the waveguide 104 by electroless-plating.

In the prior art waveguide, floatings and steps are generated in the base 101 and the cover 103. In other words, the adhesive strength of the adhesive is not sufficient to keep the base 101 and the cover 103 together. To solve this problem and to more tightly hold the base 101 and the cover 103 together, taking into consideration that the waveguide is used in antennas that are installed outdoor and are required to withstand adverse conditions, number of nuts and bolts (or screws) are provided that hold the base 101 and the cover 103. However, the nuts and bolts make the assembly of the waveguide troublesome.

To correct form errors of a groove (the hollow space) for a waveguide, and deformations of the groove caused by assembling of waveguide units, it is required to adjust a space volume in the inner faces of the groove by using a large number of screws.

It is an object of this invention to obtain a waveguide that is easy to assemble, has stronger fastening force between waveguide units, and is air-tightness.

It is another object of the present invention to obtain a waveguide in which form errors of the groove for the waveguide are less, and that can be more efficiently manufactured.

### DISCLOSURE OF THE INVENTION

To achieve the objects, the present invention provides a manufacturing method of a waveguide, in which a pair of waveguide units are joined together to manufacture a waveguide, the waveguide units having flange portions at both side portions such that the flange portions of one of the waveguide units are caused to abut on the flange portions of the other, and each waveguide unit having a groove for the waveguide whose inner wall face is metal-plated at a center portion thereof, comprising, a first step of forming the pair of waveguide units having through holes in the flange portions, and a second step of forming a resin cover that is filled in the through holes and covers the pair of waveguide units at least partially by, after joining the pair of waveguide units formed with the through holes, conducting insert molding on the pair of the joined waveguide units with thermoplastic resin.

According to this invention, the resin covert hat is filled in the through holes and covers at least the outer faces facing matching faces of the flange portions are formed by, after forming the through holes in the flange portions of the waveguide units, and joining the pair of waveguide units formed with the through holes, conducting insert molding on the pair of the joined waveguide units with thermoplastic resin. Therefore, assembling of the waveguide without using screws can be realized to improve assembling efficiency, and to reduce assembling cost. The fastening force between the waveguide units may be increased, and the air-tightness and the electrical sealing may be improved, as the contact pressure between the matching faces is increased by shrinkage of the resin filled into the through holes. Accordingly, a high-performance waveguide may be provided.

According to the manufacturing method of the next invention, in the above invention, the pair of waveguide units are formed of resin, a resin cover that covers the entire outer face of the waveguide units is formed at the second step.

According to this invention, a waveguide with excellent weather-resistance against wind and rain may be realized even when the waveguide units are formed of a resin, as the resin cover that covers the entire outer side faces of the waveguide units formed of a resin are configured to be formed.

According to the manufacturing method of a waveguide of the next invention, in the above invention, at the second step, after the pair of waveguide units formed with the through holes are joined, both end faces of the pair of joined waveguide units is joined with a conductive plate having a rectangular opening portion corresponding to the waveguide, and a resin cover that is filled in the through holes and covers the pair of waveguide units and the conductive plate by conducting insert molding on the pair of the joined waveguide units and the conductive plate joined together with thermoplastic resin.

According to this invention, there are effects that the air-tightness at the end faces may be improved, and the electrical sealing may be prevented from damage as the end faces of the waveguide units in the longitudinal direction and the conducting plates are joined to form the resin cover.

According to the manufacturing method of a waveguide of the next invention, in the above invention, at the first step, a projection or a recess is formed on an inner face of the groove for the waveguide together with the formation of the through holes in the flange portions.

According to this invention, when it is required to adjust a space volume in the inside of the groove to correct form errors of the groove caused by resin shrinkage at injection molding of the waveguide units and by deformation of the waveguide unit at molding of an exterior component, adjusting work by which, for example, a screw hole is added after molding of the resin cover and a screw is forced into the hole is not required to reduce time for manufacturing the waveguide, as the protrusions or, recesses with a space volume necessary for adjusting are provided in the groove of the waveguide units.

According to the manufacturing method of a waveguide of the next invention, in the above invention, at the first step, the pair of waveguide units are formed using a mold provided with a movable insert for forming the protrusion or the recess.

According to this invention, the waveguide obtained after manufacturing is not required to individually be adjusted, and the productivity of manufacturing the waveguides is improved, as the waveguide units are manufactured using the mold provided with the movable insert to form the protrusions or recesses.

According to the manufacturing method of a waveguide of the next invention, in the above invention, the waveguide units are formed of a styrene resin.

According to this invention, the inner wall faces of the hollow portion in the waveguide may be reliably plated as the material used for the waveguide units is configured to be a styrene resin with excellent adhesion n for plating.

According to the manufacturing method of a waveguide of the next invention, in the above invention, the waveguide units are formed of an unsaturated polyester resin.

According to this invention, injection molding can be used, and the productivity of manufacturing the waveguide units is not damaged, as the waveguide units are formed of an unsaturated polyester resin. Moreover, as the unsaturated polyester resin has a small molding shrinkage percentage, and excellent creep resistance, form errors of the groove for the waveguide after the resin cover has been molded may be prevented from enlarging.

According to the manufacturing method of a waveguide of the next invention, in the above invention, the resin cover is formed of engineering plastics with weather-resistance.

According to this invention, the waveguide with excellent weather-resistance against wind, rain and the like may be realized, as the resin cover is formed of engineering plastics with weather-resistance.

According to the manufacturing method of a waveguide of the next invention, in the above invention, the resin cover is formed of a thermosetting resin.

According to this invention, injecting pressure is not applied on the waveguide units insert-molded, and form errors of the groove for the waveguide at forming the resin cover may be prevented from enlarging, as the resin cover is configured to be formed of a thermosetting resin such as an epoxy resin.

A waveguide according to the next invention is manufactured by any one of manufacturing methods according to the invention.

According to this invention, the waveguide with a better assembling efficiency, stronger fastening force between the waveguide units, excellent air-tightness, superior electrical sealing, small form errors of the groove for the waveguide, and efficient productivity may be provided, as the waveguide is manufactured by any one of manufacturing methods according to the invention.

### BRIEF DESCRIPTION OF THE DRAWINGS

FIG. 1 is a block diagram that shows a microwave antenna that includes a waveguide manufactured according to embodiments of the present invention;

FIG. 2 is a cross sectional view of a rectangular waveguide manufactured according to the first embodiment of the present invention;

FIG. 3 is a cross sectional view of a rectangular waveguide manufactured according to the second embodiment of the present invention;

FIG. 4 is a cross sectional view a rectangular waveguide manufactured according to the third embodiment of the present invention;

FIG. 5 is a cross sectional view of a rectangular waveguide manufactured according to the fourth embodiment of the present invention;

FIG. 6 is a cross sectional view that shows a mold with which the rectangular waveguide shown in FIG. 5 is manufactured; and

FIG. 7 is a perspective view of the prior art microwave waveguide.

### BEST MODE FOR CARRYING OUT THE INVENTION

Exemplary embodiments of the waveguides according to the present invention and the manufacturing methods thereof are explained in detail below.

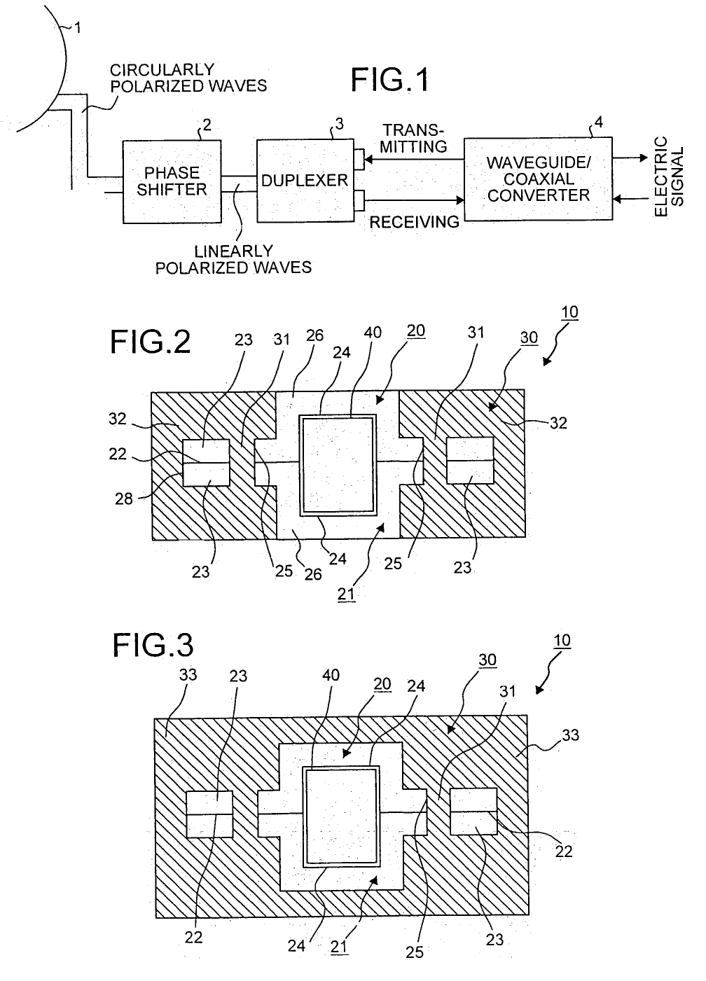

A waveguide manufactured according to the present invention is used, for example, in a duplexer 3, shown in FIG. 1, in a microwave antenna provided in a ground station for satellite communication. The microwave antenna can transmit and receive microwave signals.

The microwave antenna shown in FIG. 1 has a parabola antenna with a reflecting mirror 1. There is a 90-degree phase shifter 2 that converts the circularly polarized waves that are reflected from the reflecting mirror 1 into linearly polarized waves, and converts the linearly polarized waves that are output from the duplexer 3 into circularly polarized waves. The duplexer 3 has a branched waveguide and is used for transmitting and receiving electromagnetic waves according to their frequencies or phases. There is a waveguide/coaxial converter 4 that converts electromagnetic waves with a waveguide mode that propagate in the waveguide of the duplexer 3 into ones with a TEM mode for a microstrip line, and that converts the mode of electromagnetic waves from the microstrip line from the TEM one into the waveguide one. The duplexer 3 has a short-circuit board (not shown) that comprises a metal plate.

First Embodiment

FIG. 2 shows a cross sectional view of a rectangular waveguide 10, used in the duplexer 3, according to the first embodiment of the present invention. This waveguide 10 comprises a pair of waveguide units 20 and 21, and a resin cover 30 that surrounds and covers the waveguide units 20 and 21.

The waveguide units 20 and 21 are made of a metal such as aluminum, and they have the same thickness. Each of the waveguide units 20 and 21 has flange portions 23 that include a matching face 22 at both side portions such that the flange portions of one of the waveguide units are caused to abut on the flange portions of the other, and comprises groove forming sections 26 in which a rectangular groove 24 for the waveguide is formed at the center portion. The groove forming sections 26 are protruding from the flange portion 23. One or a plurality of through holes 25 are formed along the waveguide in the flange portions 23 formed at each side portion, respectively. A hollow body for the waveguide is formed by joining the pair of the waveguide units 20 and 21 with the configuration together so that their matching faces 22 rest on each other.

The inner wall faces of the hollow body obtained by joining the pair of the waveguide units 20 and 21 together are coated with metal plating 40 such as gold one, nickel one, and copper one. The resin cover 30 comprises portions 31 with which the through holes 25 are in filled, and portions 32 that cover the outer faces of the flange portions 23 in the waveguide units 20 and 21, and the outer side faces of the groove forming sections 26. In this case, the outer side faces of the groove forming sections 26 in the waveguide units 20 and 21 are exposed to the outside, as a weather-resistant metal (for example, aluminum) is used for the waveguide units 20 and 21. Obviously, the outer side faces of the groove forming sections 26 may be also covered with the resin cover 30.

The waveguide 10 shown in FIG. 2 is manufactured with the following method.

(1) Making Waveguide Units with Through Holes

The waveguide units 20 and 21 with the groove 24 shown in FIG. 2 are formed by suitable metal processing such as press working. Further, the through holes 25 are formed along the groove 24 in the flange portions 23 of the waveguide units 20 and 21.

(2) Plating

The inner wall faces of the groove forming sections 26 in the waveguide units 20 and 21, that is, the inner wall faces of the waveguide 10 are coated with the metal plating 40 such as gold one, nickel one, and copper one.

(3) Molding of Resin Cover

After joining the pair of the waveguide units 20 and 21, in which the through holes have been formed, together, the pair of the waveguide units 20 and 21 joined together are arranged in a mold of a cavity shape corresponding to that of the waveguide 10. Then, the resin cover 30 that comprises, as shown in FIG. 2, portions 31 filled into the through holes 25, and portions 32 that cover the outer faces of the flange portions 23 in the waveguide units 20 and 21, and the outer side faces of the groove forming sections 26 is formed by insert molding executed using a thermoplastic resin such as a polycarbonate resin with excellent weather-resistance. By the resin cover 30, the pair of the waveguide units 20 and 21 are fastened from the outside, and wind and rain are prevented from entering into the inside of the waveguide 10.

In the first embodiment, the through holes 25 are formed on the flange portions 23 of the waveguide units 20 and 21, and the waveguide units are joined together. Thereafter, insert molding of the pair of the joined waveguide units 20 and 21 is executed using a thermoplastic resin to form the resin cover 30. By the resin cover 30, the pair of the waveguide units 20 and 21 are fastened with the resin at the flange portions 23 located at the side portions, and the matching faces 22 of the waveguide units 20 and 21 are also configured to be protected from, for example, wind and rain at the outside. Accordingly, assembling of a waveguide without using screws can be realized, and assembling efficiency may be improved, based on the first embodiment. Furthermore, the fastening force between the waveguide units 20 and 21 is increased, and the air-tightness and the electrical sealing may be improved, as the contact pressure between the matching faces 22 is increased by shrinkage of the resin filled into the through holes 25.

Second Embodiment

FIG. 3 shows a waveguide 10 according to the second embodiment of the present invention. This rectangular waveguide 10 also comprises the waveguide units 20 and 21, and the resin cover 30 that surrounds and covers the waveguide units 20 and 21.

The waveguide units 20 and 21 of the second embodiment are made of a resin material, with excellent adhesion for plating, such as styrene resin (for example, ABS). Moreover, the resin cover 30 is configured to cover the entire outer faces of the waveguide units 20 and 21, as the waveguide units 20 and 21 are formed of the resin. The other portions except the portions are similar to those of the previous first embodiment.

The waveguide 10 shown in FIG. 3 is manufactured with the following method.

(1) Making Waveguide Units with Through Holes

The waveguide units 20 and 21 shown in FIG. 3, with the groove 24 and the through holes 25 are formed by injection molding. In such a case, the resin material used for the waveguide units 20 and 21 is a resin material with excellent adhesion for plating such as a styrene resin (for example, ABS). Polystyrene, high impact polystyrene, styrene-acrylonitrile copolymer, styrene-methyl-methacrylate copolymer, styrene-acrylonitrile-methyl-methacrylate copolymer, ABS resin, AES resin, AAS resin, MBS resin, ABSM resin and the like may be listed as the styrene resin.

(2) Plating

The inner wall faces of the groove forming sections 26 in the waveguide units 20 and 21, that is, the inner wall faces of the waveguide 10 are coated with the metal plating 40. The plating may be of gold, nickel, or copper.

(3) Molding of Resin Cover

After joining the pair of the waveguide units 20 and 21, in which the through holes have been formed, together, the pair of the waveguide units 20 and 21 joined together are arranged in a mold of a cavity shape corresponding to that of the waveguide 10. Then, the resin cover 30 that comprises, as shown in FIG. 3, portions 31 filled into the through holes 25, and portions 33 that cover the entire outer side faces of the waveguide units 20 and 21 is formed by insert molding executed using a thermoplastic resin material such as engineering plastics with excellent weather-resistance. By the resin cover 30, the pair of the waveguide units 20 and 21 are fastened from the outside, and wind and rain are prevented from entering into the inside of the waveguide 10. Polycarbonate resin, liquid crystal polyester resin, AES resin, acrylate resin and the like may be listed as the engineering plastics.

In this second embodiment, after the through holes 25 are formed on the flange portions 23 of the waveguide units 20 and 21 formed of the resin, and the pair of the waveguide units, in which the through holes 25 are formed, are joined together, insert molding of the pair of the joined waveguide units 20 and 21 is executed using a thermoplastic resin to form the resin cover 30. By the resin cover 30, the waveguide units 20 and 21 are fastened from the outside, and the matching faces 22 of the waveguide units 20 and 21 are also configured to be protected from, for example, wind and rain at the outside. Accordingly, assembling of the waveguide without using screws can be realized, and assembling efficiency may be improved, based on the second embodiment. Furthermore, the fastening force between the waveguide units 20 and 21 is increased, and the air-tightness and the electrical sealing may be improved, as the contact pressure between the matching faces 22 is increased by shrinkage of the resin filled into the through holes 25. In addition, the inner wall faces of the hollow portion in the waveguide may be reliably plated as the resin material used for the waveguide units 20 and 21 is configured to be a resin material with excellent adhesion for plating such as the styrene resin.

Third Embodiment

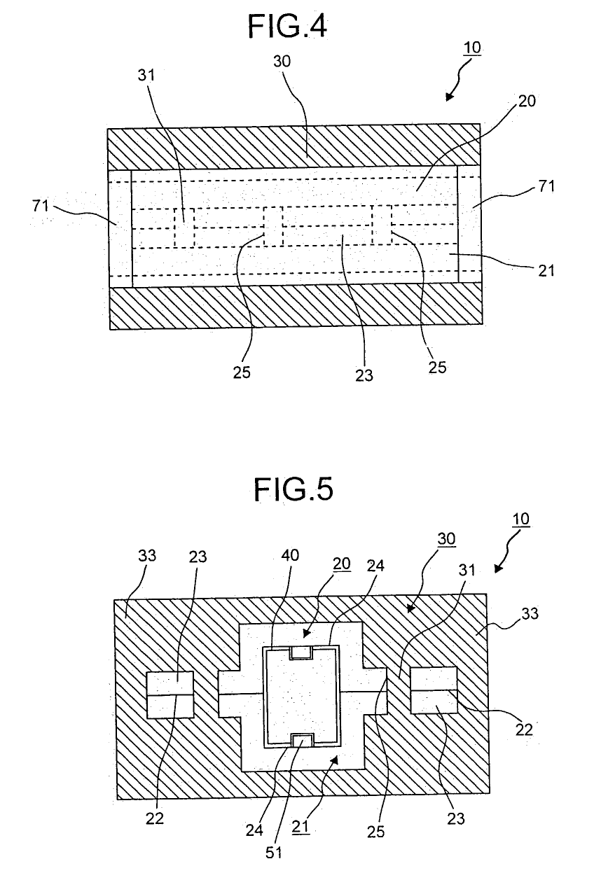

FIG. 4 shows a waveguide 10 according to the third embodiment of the present invention. FIG. 4 shows a cross sectional view taken in the direction along the longitudinal direction of a groove of the waveguide 10. This waveguide 10 also comprises the waveguide units 20 and 21, and the resin cover 30 that surrounds and covers the waveguide units 20 and 21.

In the third embodiment, after the pair of the waveguide units 20 and 21, in which through holes have been formed, are joined together, the conducting plates 71 (for example, oxygen-free copper plates) with a rectangular opening portion corresponding to a waveguide and the both end faces of the waveguide units in the longitudinal direction are joined together.

The waveguide units 20 and 21 in which the conducting plates 71 are joined at the both end faces are arranged in a mold of a cavity shape corresponding to that of the waveguide 10. Subsequently, insert molding of the waveguide units 20 and 21 is executed using a thermoplastic resin such as a polycarbonate resin with excellent weather-resistance to form the resin cover 30 in which the through holes 25 are filled, and the portions 32 (refer to FIG. 3) covering the outer side faces are included as shown in FIG. 4.

As described above, according to the third embodiment, wind and rain may be prevented from entering into the inside of the waveguide 10, and the electrical sealing may be prevented from damage, as the pair of the waveguide units 20 and 21 are fastened from the outside, and, at the same time, the conducting plates 71 joined to the end faces of the waveguide units are done through the resin cover 30.

Though a case for manufacturing the waveguide in which the conducting plates 71 are added to the configuration of the second configuration has been explained in the description, a waveguide in which the conducting plates 71 are added to the configuration of the first configuration may be configured to be manufactured. Even in this third embodiment, a resin material used for the waveguide units 20 and 21 may be a resin material with excellent adhesion for plating such as the styrene resin (for example, ABS), is listed in the second embodiment. Moreover, though a case such that the oxygen-free copper plate has been used for the conducting plates 71 has been explained in the third description, a plate obtained by plating another metal plate such as an aluminum one, an iron one, or a SUS one, or a resin plate may be applied.

Fourth Embodiment

FIG. 5 shows a waveguide 10 according to the fourth embodiment of the present invention. This rectangular waveguide 10 also comprises the waveguide units 20 and 21, and the resin cover 30 that surrounds and covers the waveguide units 20 and 21.

In this fourth embodiment, protrusions 51 are provided on the inner faces of the waveguide units 20 and 21 to correct form errors in a groove after assembling and to reduce the space volume of the groove. The other portions except the portions are similar to those of the previous second embodiment.

The waveguide 10 shown in FIG. 5 is manufactured with the following method. That is the waveguide units 20 and 21 with the groove 24, the protrusions 51, and the through holes 25 are formed by injection molding. A resin material used for the waveguide units 20 and 21 may be a resin material with excellent adhesion for plating such as the styrene resin (for example, ABS), which is listed in the second embodiment. Thereafter, the waveguide 10 is manufactured by plating and molding of the resin cover 30 using the same material and the same method with those of the second embodiment. Here, recesses, instead of the protrusions 51, may be configured to be formed.

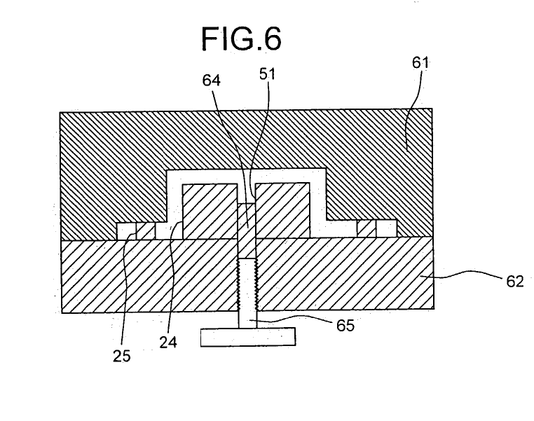

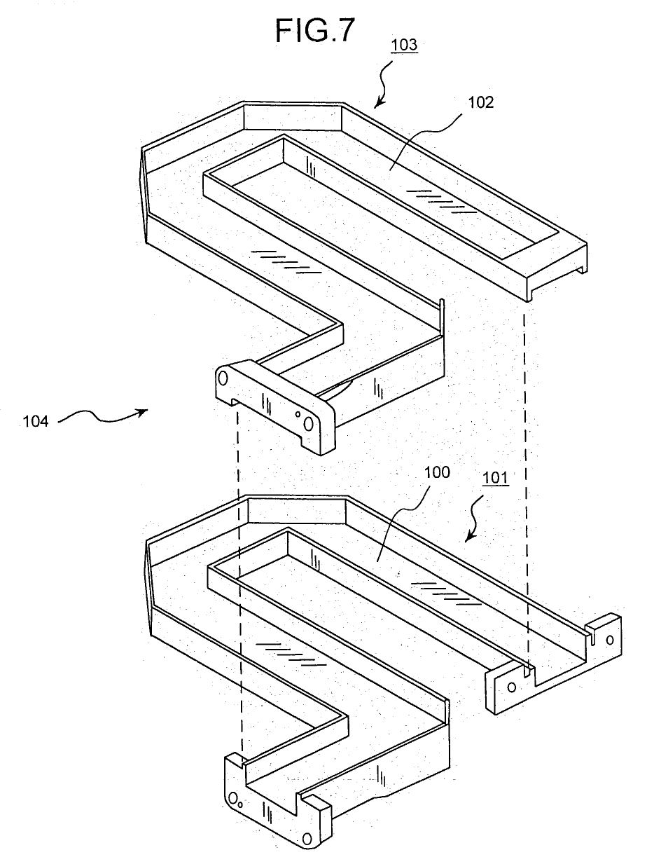

FIG. 6 shows a cross section of a mold by which injection molding of the waveguide units 20 and 21 with the groove 24, the protrusions 51, and the through holes 25 shown in FIG. 5 is executed.

The mold is provided with a movable insert 64, and a position-adjusting screw 65 in addition to an upper mold 61, and a lower mold. The insert 64 is provided in the lower mold 62 to form the protrusions 51. The positioning-adjusting screw 65 is connected to the insert 64, and the position of the insert 64, that is, the heights of the protrusions 51 may be adjusted by turning the positioning-adjusting screw 65.

In this mold, the position of the movable insert 64 is adjusted with the insert-adjusting screw 65 provided in the lower mold 62 for fixing at an adjustment position to reduce the space volume in the inside of the groove, or to form a space corresponding to an increase amount of the space volume, and, then, form errors of the groove for the waveguide caused by molding shrinkage of a resin used for the waveguide and by molding of the resin cover 30 is corrected. Thereafter, the upper mold 61 and the lower mold 62 are closed, and insert molding is executed to form the waveguide units 20 and 21 provided with the protrusions 51 (or recesses) in the inside of the groove for the waveguide.

In this fourth embodiment, similar effects to those of the second embodiment may be obtained. Moreover, when it is required to adjust the space volume in the inside of the groove to correct form errors of the groove caused by resin shrinkage at insert molding of the waveguide units and by deformation of the waveguide unit at molding of an exterior component (the resin cover 30), an adjusting work by which, for example, a screw hole is added after molding of the resin cover 30 and a screw is forced into the hole is not required, as the protrusions (or, recesses) with a space volume necessary for adjusting are provided in the groove of the waveguide units. Accordingly, time to manufacture the waveguide may be reduced.

When the waveguide units are manufactured using the mold provided with the movable insert to form the protrusions or recesses, the productivity of manufacturing the waveguides is improved as the waveguide obtained after manufacturing is not required to individually be adjusted with, for example, a screw.

Fifth Embodiment

As the fifth embodiment of the present invention, an unsaturated polyester resin (for example, RIGOLAC BMC, RNC413 made by Showa Highpolymer Co., Ltd.), which is obtained by mixing from 5 to 10% polystyrene resin, from 10 to 20 weight % glass fiber, and 60 weight % calcium carbonate, is used to form waveguide units 20 and 21. Thereafter, the resin cover 30 is formed in a similar manner to that of the second embodiment. As the unsaturated polyester resin can be used for insert molding, the productivity of manufacturing the waveguide units is not decreased. Moreover, as the unsaturated polyester resin has a small molding shrinkage percentage, and excellent creep resistance, form errors of a groove for a waveguide after the resin cover 30 has been molded may be prevented from enlarging.

Sixth Embodiment

A sixth embodiment of the present invention is explained. In the sixth embodiment, after waveguide units 20 and 21 are formed in a similar manner to the manufacturing method of the second embodiment, cast molding of a thermosetting resin such as an epoxy resin (for example, an epoxy-resin principal ingredient XNR4153P/a hardening agent XNH4153 made by Vantico), which is obtained by mixing from 60 to 80% silicon dioxide, is executed to form the resin cover 30.

Form errors of a groove for a waveguide at forming the resin cover 30 may be prevented from enlarging, as injecting pressure is not applied in a manufacturing method using the thermosetting resin such as the epoxy resin on the waveguide units insert-molded.

Though the side faces 28 (refer to FIG. 2) of flange portions 23 in the waveguide units 20 and 21 have been also covered by the resin cover 30 in the embodiments, the side faces 28 may be exposed. But the weather-resistance of a waveguide 10 against wind and rain would be reduced in such a case. That is, the resin cover 30 may be formed in such a way that the through holes 25 are filled and at least the outer faces facing matching faces 22 of the flange portions 23 are covered.

A material used for the waveguide units 20 and 21 may be an arbitrary metal or resin. Moreover, though the present invention has been applied for a rectangular waveguide in the embodiments, the present invention may be also applied for a circular waveguide.

A waveguide that has made using the manufacturing method according to the present invention may be applied not only for a microwave transmitter-receiver shown in FIG. 1 and is used for satellite communication, but also for other arbitrary communication devices, and electronic devices.

### INDUSTRIAL APPLICABILITY

The present invention is preferably used for a waveguide included in a duplexer and the like in a microwave antenna provided in a ground station for satellite communication.

1. A manufacturing method of a waveguide, wherein the waveguide includes two waveguide units that are joined together, each waveguide unit having flange portions at both side portions thereof such that the flange portions of one of the waveguide units are caused to abut on the flange portions of the other waveguide unit, each waveguide unit having a groove at a center portion thereof for guiding waves, inner wall of the groove being metal-plated, the method comprising:
a first step of forming the waveguide units having through holes in the flange portions; and
a second step of forming a resin cover that is filled in the through holes and covers both the waveguide units at least partially by, after joining the waveguide units formed with the through holes, conducting insert molding on the two waveguide units with thermoplastic resin.

2. The manufacturing method according to claim 1, wherein the waveguide units are formed of resin, and
the resin cover formed at the second step is such that it covers the entire outer face of both the:waveguide units.

3. The manufacturing method according to claim 1, wherein at the second step, after the waveguide units formed with the through holes are joined, both end faces of the joined waveguide units is joined with a conductive plate having a rectangular opening portion corresponding to the waveguide, and a resin cover that is filled in the through holes and covers the pair of waveguide units and the conductive plate by conducting insert molding on the pair of the joined waveguide units and the conductive plate joined together with thermoplastic resin.

4. The manufacturing method according to claim 1, wherein at the first step, a projection or a recess is formed on an inner face of the groove together with the formation of the through holes in the flange portions.

5. The manufacturing method according to claim 4, wherein at the first step, the waveguide units are formed using a mold provided with a movable insert for forming the protrusion or the recess.

6. The manufacturing method according to claim 1, wherein the waveguide units are formed of a styrene resin.

7. The manufacturing method according to claim 1, wherein the waveguide units are formed of an unsaturated polyester resin.

8. The manufacturing method according to claim 1, wherein the resin cover is formed of engineering plastics with weather-resistance.

9. The manufacturing method according to claim 1, wherein the resin cover is formed of a thermosetting resin.

10. A waveguide including two waveguide units that are joined together, each waveguide unit having flange portions at both side portions thereof such that the flange portions of one of the waveguide units are caused to abut on the flange portions of the other waveguide unit, each waveguide unit having a groove at a center portion thereof for guiding waves, and an inner wall of the groove being metal-plated, the waveguide being manufactured by a method comprising:
a first step of forming the waveguide units having through holes in the flange portions; and
a second step of forming a resin cover filled in the through holes and covers both the waveguide units at least partially by, after joining the waveguide units formed with the through holes, conducting insert molding on both the waveguide units with thermoplastic resin.

11. The waveguide according to claim 10, wherein the waveguide units are formed of resin, and
the resin cover formed at the second step is such that it covers the entire outer face of the waveguide units.

12. The waveguide according to claim 10, wherein at the second step, after the waveguide units formed with the through holes are joined, both end faces of the joined waveguide units is joined with a conductive plate having a rectangular opening portion corresponding to the waveguide, and a resin cover filled in the through holes and covers the waveguide units and the conductive plate by conducting insert molding on the joined waveguide units and the conductive plate joined together with thermoplastic resin.

13. The waveguide according to claim 10, wherein at the first step, a projection or a recess is formed on an inner face of the groove for the waveguide together with the formation of the through holes in the flange portions.

14. The waveguide according to claim 13, wherein at the first step, the waveguide units are formed using a mold provided with a movable insert for forming the protrusion or the recess.

15. The waveguide according to claim 10, wherein the waveguide units are formed of a styrenes resin.

16. The waveguide according to claim 10, wherein the waveguide units are formed of an unsaturated polyester resin.

17. The waveguide according to claim 10, wherein the resin cover is formed of engineering plastics with weather-resistance.

18. The waveguide according to claim 10, wherein the resin cover is formed of a thermosetting resin.
